(19) United States
(12) Patent Application Publication
(10) Pub. No.: US 2008/0181355 A1
(43) Pub. Date: Jul. 31, 2008

(54) METHOD AND ARRANGEMENT RELATING TO X-RAY IMAGING

(75) Inventors: Magnus Hemmendorff, Arsta (SE); Mats Danielsson, Taby (SE)

Correspondence Address: SYNNESTVEDT LECHNER & WOODBRIDGE LLP, P O BOX 592, 112 NASSAU STREET, PRINCETON, NJ, 08542-0592, US

(73) Assignee: SECTRA MAMEA AB, Kista (SE)

(21) Appl. No.: 11/669,926

(22) Filed: Jan. 31, 2007

(51) Int. Cl. H05G 1/60

(52) U.S. Cl. 378/4

(57) ABSTRACT

To enhance image acquisition and speed up the examination during x-ray examinations, the present invention relates to an X-ray apparatus for three dimensional imaging and in particular for tomosynthesis examination, comprising a means for obtaining a set of projection images of a body part, a reconstruction means for reconstructing a three-dimensional image volume, memory for storing the projection images, and a control means. The reconstruction arrangement is arranged to reconstruct a three-dimensional image volume from data in the projection images in the memory, the reconstruction arrangement being arranged to reconstruct a first and a second image volume, wherein the second image volume is reconstructed having lower resolution than the first image volume.

### TECHNICAL FIELD OF THE INVENTION

The present invention relates to a method and arrangement in X-ray imaging, in particular three-dimensional imaging, and more especially tomosynthesis.

### BACKGROUND OF THE INVENTION

Tomosynthesis is used to create a three-dimensional image volume of a person's body part, e.g. her breast, or an object, using X-rays. Currently, tomosynthesis breast imaging is available only for research purposes, but an increasing number of market analysts believe that tomosynthesis breast imaging will become more widely used than conventional two-dimensional mammography.

Tomosynthesis is essentially a limited form of Computed Tomography (CT). Normally, several projection images, e.g. 5 or 30, are acquired from slightly different angles, using a modified X-ray system. Each projection image is essentially a conventional 2-dimensional digital X-ray image of the examined object. The projection images are then combined using special purpose software for reconstruction of a 3-dimensional image volume, which is a 3-dimensional array of voxels, wherein each voxel is essentially a value corresponding to X-ray attenuation in one location of the real world. The image volume may also be regarded as a stack of layers, wherein each layer is a 2-dimensional image. The stack of images can be displayed in a sequence.

In breast imaging, efficient workflow is very important, in particular for specialized screening mammography clinics where healthy patients are examined on a regular basis. Speed requirements and cost control have driven many mammography clinics to introduce a workflow that resembles an assembly line at a factory. Most often, patients leave the clinics before a radiologist looks at the images. Thus, the demands and requirements for breast imaging systems are different compared to other applications of medical X-ray imaging.

The reconstruction time is a problem in breast imaging, due to high demands for speed, and computationally expensive reconstruction algorithms. The long processing time arises partly due to truncation of the object at the border of projection images. Truncation cause difficulties when using the same methods as for mainstream CT, such as filtered back-projection and direct Fourier methods. Another problem is that it is desired to produce an image volume with many more voxels than there are pixels in the stack of projection images, which calls for regularization when using iterative methods. Recent research indicates that image quality can be improved using extremely computationally expensive regularization, such as the TV-norm regularization (e.g. Sidky, Kao, Pan 2006). Therefore, it is expected that reconstruction time or computational cost will remain a challenge for many years to come.

The long reconstruction time is a problem in normal workflow, wherein the operator of the X-ray apparatus looks at the acquired image and determines whether or not it can be used for diagnosis. In case of failure, a new image must be taken before the patient leaves the examination. The main risk of failure is bad positioning, wherein an important part of the breast is not visible. Other risks for reconstruction are apparatus failure, large dirt particles, silicon implants and metal pieces such as piercing.

According to prior art, projection images may be previewed. Unfortunately, each projection image tends be characterized by a substantially worse image quality than a reconstructed volume, since it contains the combination of X-ray quantum noise and disturbing super-imposed tissue. Normally, each projection image is very noisy, since each projection image is acquired using fraction of the total dose.

Image quality is important for preview in non-screening breast imaging, wherein patients have been called back to further study something that was seen in earlier images. The operator of the X-ray apparatus shall look in the image to determine whether or not that something is visible and well depicted in the image. If not, the operator may acquire another image with a different positioning.

### SUMMARY OF THE INVENTION

The object of the present invention is to provide an effective aid for quickly determining whether or not a tomosynthesis image acquisition was successful. The aid is quick enough to fit in the workflow of virtually any modern mammography clinic. The aid is also inexpensive to manufacture.

For these reasons, an arrangement for a quick three-dimensional volume preview is presented.

The present invention effectively reduces the risk of a patient needs to be recalled due to bad image quality.

In contrast to prior art, wherein the projection images are displayed as a preview, the present invention
more accurately indicates whether or not positioning was good,
enables the operator to see whether or not the image reconstruction will work, which is particularly important in presence of highly attenuating materials such as silicon implants and metal pieces,
provides better image quality than mere projection images, and
provides a full image despite individual projection images contain gaps.

The present invention produces and outputs two image volumes from the same set of projection images, a preview image volume and a high quality diagnostic image volume. According to the present invention, a preview image volume is reconstructed using projection images at a lower resolution. There are two different pipes of processing for preview image volume and the diagnostic image volume.

Preferably, the full projection images are stored in a first memory buffer. The contents of this memory buffer will be used for reconstructing the diagnostic image volume, but that may wait. The primary focus is reconstruction of a preview image volume. Preferably, the projection images are sub-sampled, and the sub-sampled data is stored in a second buffer, which is used for reconstruction of the preview images. Preferably, the sub-sampling reduces the number of pixels by 4 or 16 times. The sub-sampled images are used for reconstructing a three-dimensional image volume, and the resolution in the image volume follows the resolution in the projection images. Preferably, the reconstruction of the preview image is performed in essentially the same way as for the diagnostic image volume, except for different parameters related to image quality and geometrical differences for the preview resolution. The primary parameter difference is that fewer layers are reconstructed, since the preview image volume shall have at least as elongated voxels as the diagnostic image volume. Thus, one octave of sub-sampling reduces the number of pixels by 2*2=4 times in the projection images, and the number of reconstructed voxels will be reduced by 2̂3=8 times. Thanks to one octave of sub-sampling, the reconstruction time will be at least 4 times, and probably close to 8 times faster. There are reasons to believe that two octaves of sub-sampling will provide enough image quality for preview, which speeds up reconstruction up to 64 times. Further speed is possible by computational approximations or sub-optimal parameters. Most tomosynthesis reconstruction algorithms are iterative (e.g. EM or Lange-Fessler 1995) and the result converges over a number of iterations. Preferably, the preview image is computed with at most half number of iterations compared to the diagnostic image volume, which doubles speed. In addition, it is possible to skip computationally expensive regularization, which simplifies computations and also tend to substantially decrease the number of iterations.

### SHORT DESCRIPTION OF THE DRAWINGS

FIG. 1 shows a schematic view of the preferred embodiment of the present invention.

### DESCRIPTION OF THE EMBODIMENTS

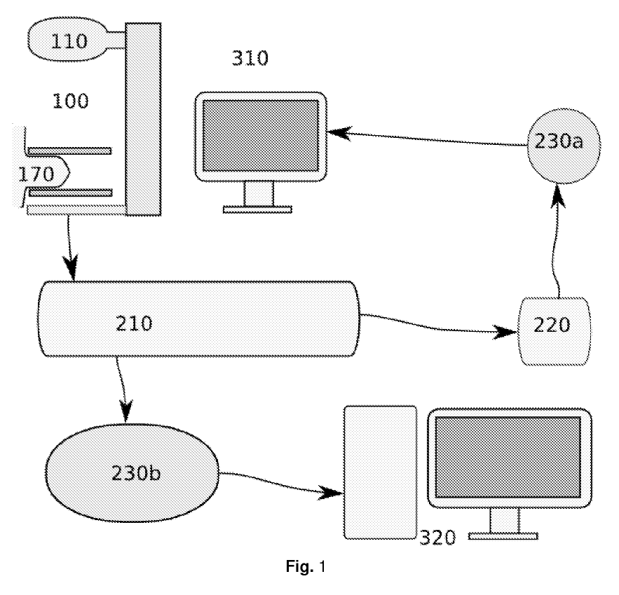

FIG. 1 shows the preferred embodiment of the present invention implemented in an X-ray acquisition device 100. The device 100 comprises an X-ray acquisition device 100, which produces a set of projection images of a compressed breast, at different angles. The full projection images are stored in a memory unit 210. From here, there are two parallel paths of processing. According to prior art, the full projection images are fed to a reconstruction means 230b, where the full projection images are combined to a three-dimensional volume, which is further used for diagnosis or exported to a Picture Archiving and Communicating System (PACS) 320. According to this embodiment of the present invention, the stored full projection images in the memory unit 210 are also fed to a preview branch, wherein the data first passes through a low resolution provider 220 for providing the projection images at a low resolution. The low resolution provider comprises a sub-sampler for conversion to low resolution image data and a smaller memory space for projection data at the low resolution. The low-resolution image data is combined in a reconstruction device 230a to a three-dimensional volume, to be shown in a display 310 for preview, which for example is located close to the X-ray acquisition device 100. In the most preferred embodiment, the preview display is part of a computer, whose primary purpose is to control the X-ray acquisition device 100. In case of failure (bad image, misplaced position, etc), the operator may request another image from a user interface on the same display.

Different embodiments of the invention may use different methods of reducing the resolution of the projection images, such as iterators or similar mechanisms for reducing or omitting pixels. The preferred embodiment of the present invention computes averages of neighboring pixels values, whereby noise is reduced. It may also be possible to leave out entire projection images, but the preferred implementation uses all available projection images.

In the most preferred embodiment of the present invention, the projection images are acquired using a multi-slit scanner, wherein the x-ray source and detector rotate around a common rotation axis in order to simultaneously obtain a set of projection images. The images are reconstructed in a coordinate system, which is curved around the rotation axis, like polar coordinates. Thanks to the curved coordinate system, slabs of the image volume can be reconstructed with very little dependence on data pixels and voxels outside the thin slab. The low dependence enables massive parallelism when computing the diagnostic image volume. The coordinate system turns out to be even more advantageous when computing the preview image volume. After sub-sampling, the dependence is negligible, and it is possible to perform reconstruction by massive parallelism, wherein each cell of parallelism is based on only one pixel column from each projection image. After sub-sampling, the data set is small enough to fit into the CPU cache in a normal computer, which further speeds up the calculation. Each column can be processed as a vector with constant address shifts, whereby the preferred implementation is suitable vector operations and Single Instruction, Multiple Data (SIMD) instructions in computer hardware. The current trends of computer hardware are parallelism by threads, parallelism by vector operations and increasing speed difference of access to CPU cache compared to Random Access Memory (RAM). The preferred implementation is promising with respect to all major trends fits well into all of these trends in modern computer hardware.

The preferred embodiment of the present invention is inexpensive and provides a tentative image much faster than the diagnostic image volume, thus re-calls of patients may be avoided.

Another aspect of the present invention is a reconstruction of a second diagnostic image volume, based from the same projection image data. A second main diagnostic image volume may be computed whenever the diagnosis is unusually difficult, or there are special image artifacts, which require an extra powerful method for reconstruction.

The invention may also be implemented as computer program comprising procedures for executing the steps mentioned earlier.

The invention is not limited to the shown embodiments but can be varied in a number of ways without departing from the scope of the appended claims and the arrangement and the method can be implemented in various ways depending on application, functional units, needs and requirements etc. The reconstruction arrangement can of course be used in other x-ray applications.

The above mentioned and described embodiments are only given as examples and should not be limiting to the present invention. Other solutions, uses, objectives, and functions within the scope of the invention as claimed in the below described patent claims should be apparent for the person skilled in the art.

What we claim is:

1. An X-ray apparatus for three dimensional imaging and in particular for tomosynthesis examination, comprising a means for obtaining a set of projection images of a body part, a reconstruction means for reconstructing a three-dimensional image volume, memory for storing said projection images, and a control means, wherein said reconstruction arrangement is arranged to reconstruct a three-dimensional image volume from data in said projection images in said memory, said reconstruction arrangement being arranged to reconstruct a first and a second image volume, wherein said second image volume is reconstructed having lower resolution than said first image volume.

2. The X-ray apparatus according to claim 1, wherein said reconstruction arrangement is setup such that time for performing reconstruction for said second image volume is faster than for said first image volume.

3. The X-ray apparatus according to claim 1, further comprising a sub-sampling means for conversion of said projection images to lower resolution prior to said reconstruction means.

4. The X-ray apparatus according to claim 3, wherein said reconstruction means is setup to compute said first and second image volumes based on a common set of projection images.

5. The X-ray apparatus according to claim 3, wherein said sub-sampling means involves a mechanism for omitting pixels or merging neighboring pixels.

6. The X-ray apparatus according to claim 3, further comprising a means for automatically displaying said second image volume to an operator of said apparatus, and a means for automatically exporting said first image volume to another computer system.

7. An X-ray apparatus for three dimensional imaging and in particular for tomosynthesis examination, comprising a means for obtaining a set of projection images of a human breast, a multi-resolution means for accessing said projection images at a first and a second resolution, a display means, a means for reconstruction of a first image volume from said projection images at said first resolution, and a means for reconstruction of a second image volume from said projection images at said second resolution, wherein said second resolution is substantially higher than said first resolution, and said display means is setup to output said first image volume before said second image volume is fully reconstructed.

8. The X-ray apparatus according to claim 7, wherein said multi-resolution means comprises a memory space for keeping projection images at a high resolution and a means for converting data to a lower resolution.

9. The X-ray apparatus according to claim 8, further comprising a means for automatically exporting said second image volume to an external computer system, which is not part of said X-ray apparatus.

10. An arrangement for connection to an x-ray apparatuses for three dimensional imaging and in particular for tomosynthesis examination, comprising a communication means for obtaining a set of projection images of a body part from said x-ray apparatus, a reconstruction arrangement for reconstructing a three-dimensional image volume, memory for storing said projection images, and a control arrangement, wherein said reconstruction arrangement is arranged to reconstruct a three-dimensional image volume from data in said projection images in said memory, said reconstruction arrangement being arranged to reconstruct a first and a second image volume, wherein said second image volume is reconstructed having lower resolution than said first image volume.

11. A method in tomosynthesis for producing a diagnostic three-dimensional image volume, comprising the steps of acquiring a set of projection images of a body part, storing said projection images in a memory space, and using said projection images in a first and a second sequence of steps, wherein said first sequence comprises the steps of producing projection image data at lower reduced resolution from said projection images, reconstructing said three-dimensional preview image from said projection image data at lower resolution, and finally displaying said preview image, and said second sequence of steps comprises the steps of reconstructing said diagnostic three-dimensional image volume from said projection images, and output said diagnostic three-dimensional image volume.

12. A computer program comprising a set of instructions for receiving a set of projection images, keeping said projection images in a memory space, providing said projection images in a first and a second resolution, reconstructing a first image volume from said projection images at said first resolution, reconstructing a second image volume said projection images at said second resolution, and output of said first image volume to a first destination and output said second image volume to a second destination, wherein said second resolution is substantially higher than said first resolution.

13. The computer program according to claim 12, wherein said first destination is a display and said second destination is another computer system.

14. The computer program according to claim 12, wherein said first destination is a display, and said computer program further comprises instructions for controlling the source of said projection images.

15. The computer program according to claim 12, further comprising instructions for controlling the source of said projection images, and said first destination is a display.
